(19) United States
(12) Patent Application Publication
(10) Pub. No.: US 2023/0264454 A1
(43) Pub. Date: Aug. 24, 2023

(54) SAFETY WINDOW FILM INCLUDING POLYURETHANE

(71) Applicant: 3M INNOVATIVE PROPERTIES COMPANY, St. Paul, MN (US)

(72) Inventors: Lesbia Giron, Roseville, MN (US); Keith Lyon, Hudson, WI (US); Jay Jennen, Forest Lake, MN (US); Zoong Yang, Maplewood, MN (US)

(21) Appl. No.: 18/010,592

(22) PCT Filed: Jun. 28, 2021
(86) PCT No.: PCT/IB2021/055776

§ 371 Date: Dec. 15, 2022

Related U.S. Application Data
(60) Provisional application No. 63/047,711, filed on Jul. 2, 2020.

(51) Int. Cl. B32B 17/10; B32B 7/12; B32B 27/36; B32B 27/08; C09J 7/25; C09J 7/38; C09J 7/29; E06B 5/10

(52) U.S. Cl. CPC B32B 17/10018; B32B 7/12; B32B 17/1077; B32B 27/36; B32B 27/08; C09J 7/25; C09J 7/38; C09J 7/29; E06B 5/103; B32B 2307/7376; B32B 2307/748; B32B 2307/536; C09J 2475/006; C09J 2203/346

(57) ABSTRACT

Safety window films are described. In particular, safety window films including a substrate including polyurethane—the substrate having a first and second major surface, an optically clear pressure sensitive adhesive, and a polymeric liner are described. The first major surface of the substrate is the top surface of the safety film, and the polyurethane has a Shore hardness of less than 80 D. Such films may provide improved physical and optical performance over conventional safety window films, while being easier to install.

### BACKGROUND

Safety window films are used to provide an additional barrier substrate to a glass window that has different physical properties. A polymeric film installed as a safety window film may slow a break-and-entry attempt, provide protection against physical impacts, or reduce the number of free-flying shards in the case of an otherwise glass-shattering event.

### SUMMARY

In one aspect, the present description relates to a safety film. The safety film includes a substrate including polyurethane—the substrate having a first and second major surface, an optically clear pressure sensitive adhesive, and a polymeric liner. The first major surface of the substrate is the top surface of the safety film, and the polyurethane has a Shore hardness of less than 80 D.

In another aspect, the present description relates to a shatter-resistant window. The shatter-resistant window includes at least one pane of glass—the at least one pane of glass defining an interior surface and an exterior surface, a safety film laminated to the interior or exterior surface of the at least one pane of glass—the safety film including a substrate including polyurethane having a Shore hardness of less than 80 D and an optically clear pressure sensitive adhesive, the substrate having a first and second major surface. The major surface farther from the surface of the at least one pane of glass is the top surface of the safety film.

### BRIEF DESCRIPTION OF THE DRAWINGS

FIG. 1 is a schematic side elevation cross-section of a safety film.

FIG. 2 is a schematic side elevation cross-section of a shatter-resistant window.

### DETAILED DESCRIPTION

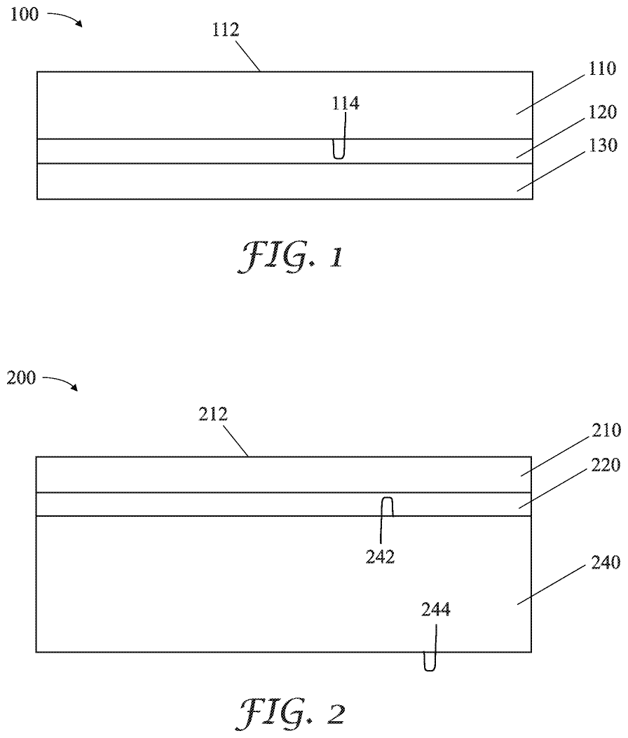

FIG. 1 is a schematic side elevation cross-section of a safety film. Safety film 100 includes substrate 110 including first major surface 112 and second major surface 114, optically clear pressure sensitive adhesive 120, and polymeric liner 130.

Safety film may be any suitable size and shape. In some embodiments, safety film 100 is precut or custom cut to the size of the window it is to be attached to. Commonly this shape is rectangular, although other shapes may be appropriate, such as full or partial circles or ellipses or another straight-sided shape. Commonly, safety film is sold or transported as a roll of film (having a certain fixed width and a very long length dimension to allow for conversion to the appropriate size and shape.

Substrate 110 may be any suitable material or combination of materials. In some embodiments, substrate 110 is or includes a layer of polyurethane. Polyurethane film may be formed through any suitable process, such as melt extrusion from pelletized raw materials. Polyurethane film substrates may be of any suitable thickness. In some embodiments, the polyurethane film substrate is between 100 micrometers and 400 micrometers thick. In some embodiments, the polyurethane is a thermoplastic polyurethane. Various polyurethanes and polyurethane blends may be characterized by their Shore hardness. In some embodiments, the polyurethane of substrate 110 may have a Shore hardness of less than 90 D, may have a Shore hardness of less than 80 D, may have a Shore hardness of less than 70 D, may have a Shore hardness of less than 100 A, may have a Shore hardness of less than 95 A, may have a Shore hardness of less than 90 A, may have a Shore hardness of less than 85 A, or may have a Shore hardness of less than 80 A. In some embodiments, the polyurethane of substrate 110 is a block copolymer made up of alternating hard and soft segments (typical for a thermoplastic polyurethane), and may be characterized as a percentage of hard segments. In some embodiments, the polyurethane of substrate 110 has less than 66% hard segments, less than 62% hard segments, less than 60% hard segments, less than 55% hard segments, less than 50% hard segments, or less than 45% hard segments.

Surprisingly, a stiffer polyurethane (or conventional, even stiffer polyethylene terephthalate) does not necessarily lead to a better performing safety window film. In contrast, a softer polyurethane may perform better across a wide variety of tests because of its conformability. Additionally, installation of safety window films is typically a wet install, meaning that soapy water is used in order to allow the film to slide until correctly positioned. This means, however, that the water must be physically forced out from between the film and the window, to avoid bubbles and other optical defects in the appearance. With conventional, stiffer films, this step is extremely labor intensive and difficult. Softer polyurethane safety films, such as the ones described herein, may make this installation step much easier and faster, with damage to the safety window film and the window itself less likely. However, films described herein may be used with any other installation methods, such as a dry lamination (using a machine to attach the film to glass before the window is installed in the building).

First major surface 112 of substrate 110 may be an external or top surface of the film. This distinction is intended to highlight that in some embodiments, there are no further materials provided on major surface 112 of substrate 110, for example, a hardcoating or an additional substrate or other layer.

In some embodiments, substrate 110 may include multiple layers. For example, in some embodiments, substrate 110 may include three layers—polyurethane, polyethylene terephthalate, and polyurethane. These layers may be laminated together with an adhesive, permanently heat bonded, or attached by any other suitable means. Other embodiments with any number of layers, such as 5 or 7, each having any suitable thickness may be desirable, depending on the application.

Optically clear pressure sensitive adhesive 120 may be any suitable adhesive applied at any suitable thickness. In some embodiments, optically clear pressure sensitive adhesive 120 is selected such that it is compatible with both substrate 110 and an expected glass window surface, to which it will be applied. In some embodiments, optically clear pressure sensitive adhesive 120 may be selected for its physical characteristics, such as its softness or hardness (elastic modulus) or its flowability. In some embodiments, optically clear pressure sensitive adhesive 120 may be selected for its optical characteristics, such as its transparency, or, more specifically its optical clarity (high), optical transmission (high), and optical haze (low). In some embodiments, optically clear pressure sensitive adhesive 120 may be an acrylic adhesive. In some embodiments, optically clear pressure sensitive adhesive 120 may be between 1 and 25 micrometers thick, between 25 and 50 micrometers thick, between 50 and 75 micrometers thick, between 75 and 100 micrometers thick, or even between 100 and 500 micrometers thick. The adhesive layer may be formed through any suitable means, and then dispensed or provided onto the substrate by any suitable method, such as through solvent or extrusion coating, or via a transfer tape or the lamination of a release liner carrying the adhesive layer (for example, polymeric liner 130 as discussed in more detail herein).

Polymeric liner 130 may be any suitable material. In some embodiments, polymeric liner 130 may be a smooth liner. In some embodiments, polymeric liner 130 has no discernable texture or repetitive structures—and is not necessarily, mathematically, completely flat (Rₐ of 0). The liner being polymeric is to distinguish it from traditional paper liners—these liners, formed from wood fibers, generally have surfaces too inherently rough for optically sensitive applications. Especially with a substrate including a soft polymer like polyurethane, a paper liner may transfer its roughness to the front or backside of the film, resulting in an ‘orange peel’ like texture that is largely objectionable for safety window film applications.

Polymeric liner 130 may be coated or uncoated. Suitable release coatings include silicones or natural waxes. The liner may also be any suitable thickness. For example, the liner may be between 25 and 100 micrometers thick. Depending on the application, the balance between easy handling, adhesion (conversely, release), and weight may suggest to the skilled person a particular material, thickness, or configuration.

FIG. 2 is a schematic side elevation cross-section of a shatter-resistant window. Shatter-resistant window 200 includes substrate 210 including first major surface 212 and a second major surface opposite the first major surface, optically clear pressure sensitive adhesive 220, and at least one pane of glass 240 having and defining interior surface 242 and exterior surface 244.

Substrate 210 is as described for substrate 110 of FIG. 1. Likewise, optically pressure sensitive adhesive 220 corresponds to optically clear pressure sensitive adhesive 220. Any polymeric liner is missing, as the substrate has been attached, via the pressure sensitive adhesive, to at least one pane of glass 240. At least one pane of glass 240 includes at least a single pane of glass, but may include or contain double- or triple-paned glass. In such cases, which are not illustrated in detail in FIG. 2, the general construction and configuration of the shatter-resistant window remains the same.

The at least one pane of glass 240, regardless of the number of panes of glass, defines an interior surface and an exterior surface, depending on how it is intended to be installed or is actually installed in a window. Most commonly, interior surface 242 is the surface to which substrate 210 is attached, as such a configuration provides protection for the film against environmental aging, such as UV, heat, and precipitation exposure. However, in some embodiments, the exterior surface 244 may be used to attach substrate 210. Such a configuration is not explicitly illustrated in FIG. 2 but may be easily understood by the skilled person. Additional protection for the film may be necessary for configurations where the film is exposed to an outdoor environment. For example, UV absorbers, UV stabilizers, or hardcoats may be included to help increase the functional lifetime of an externally positioned safety window film.

The adhesion of substrate 210 to at least one pane of glass 240 via optically clear pressure sensitive adhesive 220 may provide physical benefits to the overall window construction. For example, the attachment of the substrate to the glass pane may slow down an attempt to break a window. As the safety window film stretches and absorbs some of the impact force of the tool, the increased time necessary to tear through and create an opening sufficient to enter through may deter a criminal seeking a crime of opportunity. Similar to a car alarm as a deterrent for theft, the prolonged effort and time necessary to enter through a window having a safety window film attached may attract unwanted attention that thwarts the completion of a crime.

In some embodiments, the adhesion of substrate 210 to at least one pane of glass 240 via optically clear pressure sensitive adhesive 220 may provide break- or shatter-resistance in the event of a concussive event (an explosion or blast), a windstorm, or another type of event where acute stress is applied to the window.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

Thermoplastic polyurethane (TPU) films were made with polyurethane resin in pellet form, were coated with an adhesive, and had their physical properties measured. The film was also laminated to annealed glass panels and subjected to impact testing.

All parts, percentages, ratios, etc. in the examples and the rest of the specification are by weight, unless noted otherwise. The following abbreviations are used herein: N-m=newton-meter, cm=centimeter, mm=millimeter, ° F.=Fahrenheit, J=joules, mm/min=millimeter per minute, μm=micrometer, “=inches, %=percent, MD=machine direction, TD=transverse direction.

### Materials:

| Abbreviation | Description |
|---|---|
| R1 | Polyurethane resin, thermoplastic pellet available from |
| | Lubrizol, Wickliffe, OH as TECOFLEX CLA-93A-V |
| PET1 | 3M Company, St. Paul, MN, as SCOTCHSHIELD Ultra S800 |

### Test Methods:

Physical Properties

The following tests were conducted using a Universal Testing System, Model #5965U2578, Instron, Norwood, Mass. The area under the stress-strain curve provided an indication of the high energy absorption of the film and the resistance of the film to tear.
1. Trouser Tear in accordance with ASTM D1938-19 Standard Test Method for Tear-Propagation Resistance (Trouser Tear) of Plastic Film and Thin Sheeting by a Single-Tear Method. A modification to the tear speed rate was modified to 12700 mm/min speed rate.
2. Graves Tear in accordance with ASTM D 1004-13 Standard Test Method for Tear Resistance (Graves Tear) of plastic film and Sheeting. Following modification to the test were made:
   a. Sample width was 38.1 mm
   b. Speed rate 12700 mm/min
3. Elongation in accordance with ASTM D-882-18 Standard Test Method for Tensile Properties of Thin Plastic Sheeting. Speed rate was modified to 12700 mm/min
4. Puncture in accordance with ASTM D7192-20 Standard Test Method for High Speed Puncture Properties of Plastic Films Using Load and Displacement Sensors. Modification to the test included no use of rubber gaskets for clamping, drop velocity of 2.45 m/s and the diameter of the exposed film for the impact is 45 mm.

Impact Properties

Samples were dry laminated on to 86.36 cm width×193.04 cm height, 0.623 cm thick annealed glass panels and evaluated in accordance with the following standards. Results are recorded as detached grams (g) of material.
1) Impact ANSI Z 97.1-2015 Class A, 542.33 J impact. for safety Materials used in buildings—Safety Performance specifications and methods of test, American National Standard
2) CPSC 1201 Safety Standard for Architectural Glazing Materials, Consumer Product Safety Commission (16 CFR Ch. II, 1-1-03 edition)

Optical Properties
Haze, clarity and transmission were measured for all samples. Test was conducted with Hunter Lab ULTRASCAN PRO, Reston, Va. Results reported in %.

### Examples (E1-2, CE1)

A thermoplastic caprolactone-based polyurethane resin R1 was extruded in a twin-screw extrusion machine, at a temperature of around 380° F. The coating die extruded a TPU film to a thickness of roughly 305 μm, onto a smooth PET casting liner that was on top of a casting wheel. The TPU Film was then fed through a lamination nip to increase the bond between the extruded TPU film and the casting liner. The edge trim was removed and the TPU film wound up on a winder. The exposed side of the TPU film was corona treated and then coated with an optically clear acrylic pressure sensitive adhesive (PSA) attached to a polymeric liner, similar to 3M Optical Clear Adhesive 8212 (available from 3M Company, St. Paul, Minn.).

Example 1 (E1) was TPU film coated with 25.4 μm PSA.
Example 2 (E2) was TPU film coated with 44.45 μm PSA.
Comparative Example 1 (CE1) was PET1 coated with 25.4 μm PSA

### Results:

TABLE 1
Physical Properties: Trouser, Graves and Puncture results

| | PSA | | | | | |
|---|---|---|---|---|---|---|
| Sample | adhesive | Trouser Tear | | Graves Tear | | Puncture |
| ID | Layer | Area under the curve | | Area under the curve | | Total |
| Film | thickness | (J) | | (J) | | Energy |
| Direction | (μm) | MD | TD | MD | TD | (J) |
| CE1 | 25.4 | 0.35 ± 0.03 | 0.42 ± 0.04 | 6.60 ± 4.0 | 2.25 ± 0.68 | 3.3 |
| E1 | 25.4 | 6.40 ± 0.37 | 6.71 ± 0.47 | 8.69 ± 0.42 | 9.05 ± 0.60 | 8.5 |
| E2 | 44.45 | 6.22 ± 0.31 | 6.19 ± 0.4 | 10.94 ± 0.67 | 10.41 ± 0.38 | 11.0 |

TABLE 2
Physical properties: Elongation

| Sample ID | Elongation (%) | |
|---|---|---|
| Film Direction | MD | TD |
| CE1 | 137 | 153 |
| E1 | 332 | 337 |
| E2 | 374 | 353 |

Trouser and Graves tear testing indicated the toughness of the TPU Film is much higher compared to PET1 film.

TABLE 3
Impact properties

| | | Impact | | Largest | | |
|---|---|---|---|---|---|---|
| | | Side | Tear after | Detached | Total | |
| | Specimen | glass/ | impact | glass | fragments | Pass/ |
| Film | Number | film | (cm) | fragment (g) | (g) | Fail |
| CE1 | 1 | Film | No tear | 6.3 | 18.1 | Pass |
| CE1 | 2 | Glass | No tear | 46.4 | 62.1 | Pass |
| CE1 | 3 | Film | No tear | 7.4 | 15.7 | Pass |
| CE1 | 4 | Glass | No tear | 25.9 | 76 | Pass |
| E1 | 1 | Film | No tear | 0.0 | 0.0 | Pass |
| E1 | 2 | Glass | No tear | 15.0 | 6.0 | Pass |
| E1 | 3 | Film | No tear | 0.0 | 0.0 | Pass |
| E1 | 4 | Glass | 1.9 × 5.72 | 0.0 | 0.0 | Pass |
| E2 | 1 | Film | No tear | 0.0 | 0.0 | Pass |
| E2 | 2 | Glass | 3.81 × 1.27 | 1.0 | 1.0 | Pass |
| E2 | 3 | Film | No tear | 0.0 | 0.0 | Pass |
| E2 | 4 | Glass | 0.64 × 1.91 | 0.0 | 0.0 | Pass |

E2 exhibited superior glass fragment retention compared to CE1.

TABLE 4
Optical Properties

| | Optical Properties | | |
|---|---|---|---|
| Sample ID | Transmission (%) | Haze (%) | Clarity (%) |
| CE1 | 88.9 | 1.26 | 99.9 |
| E1 | 90.9 | 0.76 | 99.6 |
| E2 | 91.2 | 1.17 | 98.9 |

E1 and E2 exhibit lower haze compared to the CE1. The adhesive and adhesive thickness coated on CE1 and E1 were the same.

### Installation Observations

A Thor's Hammer Squeegee Handle (GT1006) with a 5″ (12.7 cm) Blue Max Angle Cut Squeegee Blade (GT117A) from Interwest Tools (Denver, Colo.) was used to install film CE1 onto a window with soapy water applied to the window. This tool enabled the installer to exert a high force during squeegee process as needed to remove the soapy water. To install the E1 and E2 films, an Unger Handle with a Blue Max Angle Cut Squeegee Blade (GT122) from Interwest Tools (Denver Colo.) was used to remove the soapy water. This tool was used because less force was required to remove the water.

What is claimed is:

1. A safety film, comprising:
a substrate comprising polyurethane, the substrate having a first and second major surface;
an optically clear pressure sensitive adhesive; and
a polymeric liner;
wherein the first major surface of the substrate is the top surface of the safety film; wherein the polyurethane has a Shore hardness of less than 80 D.

2. The safety film of claim 1, wherein the substrate includes at least two layers.

3. The safety film of claim 2, wherein one layer of the at least two layers includes polyurethane, and at least one other layer of the at least two layers does not include polyurethane.

4. The safety film of claim 2, wherein the at least two layers are bonded together with an adhesive.

5. The safety film of claim 1, wherein the polymeric liner includes polyester.

6. The safety film of claim 1, wherein the substrate is between 100 and 360 micrometers.

7. The safety film of claim 1, wherein the substrate is a single layer.

8. A shatter-resistant window, comprising:
at least one pane of glass, the at least one pane of glass defining an interior surface and an exterior surface;
a safety film laminated to the interior or exterior surface of the at least one pane of glass, the safety film including a substrate comprising polyurethane having a Shore hardness of less than 80 D, and an optically clear pressure sensitive adhesive, the substrate having a first and second major surface;
wherein the major surface further from the surface of the at least one pane of glass is the top surface of the safety film.

9. The shatter-resistant window of claim 8, wherein the substrate of the safety film includes at least two layers.

10. The shatter-resistant window of claim 8, wherein the substrate is between 100 and 360 micrometers.
